(19) United States
(12) Patent Application Publication
(10) Pub. No.: US 2011/0072927 A1
(43) Pub. Date: Mar. 31, 2011

(54) Method and apparatus for attachment of a lead screw to a motor shaft

(76) Inventors: Russel A. Gilbas, Saybrook, CT (US); Don W. Dienst, Marlborough, CT (US)

(21) Appl. No.: 12/586,895

(22) Filed: Sep. 30, 2009

(51) Int. Cl. F16H 55/02

(52) U.S. Cl. 74/424.76

(57) ABSTRACT

A linear actuator arrangement consists of an extended lead screw terminating at one end via a conical section and a threaded rod. After completion of the motor assembly, the threaded rod at the end of the lead screw is later engaged within the threaded aperture to provide linear actuator function.

### BACKGROUND OF THE INVENTION

Methods are currently available for converting a motor rotation to a bi-directional linear motion wherein a complex interface is interconnected with the motor shaft to provide the linear movement.

Two early arrangements are described within U.S. Pat. No. 3,641,828 entitled “Rotary-Linear Motion Converter” and within U.S. Pat. No. 4,324,148 entitled “Rotary/Linear Motion Converter Assembly”.

A more recent arrangement for converting motor rotation is the use of a linear actuator whereby a lead screw is connected with the motor shaft during the motor manufacture, per se.

One example of a lead screw for a linear actuator is described within U.S. Pat. No. 7,086,303 entitled “Lead Screw for Linear Actuator and Method of Manufacturing Same”.

U.S. Pat. No. 6,422,101 entitled “Reinforced Lead Screw with Springless Ani-Backlash Nut” and U.S. Pat. No. 7,552,657 entitled “Long-Span Lead Screw Assembly with Anti-Backlash Nut” describe the arrangement of the lead screw relative to a motor rotor.

Whereas the lead screws currently employed require supplemental means for coupling to the motor shaft, or specific assembly during the motor manufacture, it would be more convenient and economically feasible to attach the lead screw directly to a motor shaft after motor manufacture, per se.

One purpose of the instant invention, accordingly, is to provide an integrated linear actuator arrangement that could be attached to the motor shaft after the motor has been completely assembled.

### SUMMARY OF THE INVENTION

A linear actuator arrangement consists of an extended lead screw terminating at one end via a conical section and a threaded rod. A conical aperture within one end of a customized rotor shaft abuts a threaded aperture formed therein.
After completion of the motor assembly including the customized rotor shaft, the threaded rod at the end of the lead screw is later fastened within the threaded aperture to provide linear actuator function.

### BRIEF DESCRIPTION OF THE DRAWINGS

FIG. 1 is a side view the customized lead screw according to the invention;

FIG. 2 is sectional side view of a motor shaft customized for threadingly receiving the lead screw of FIG. 1; and

FIG. 3 is a side view, in partial section, of the customized lead screw of FIG. 1 inserted within a motor shaft of FIG. 2 to complete the linear actuator assembly.

### DESCRIPTION OF THE PREFERRED EMBODIMENT

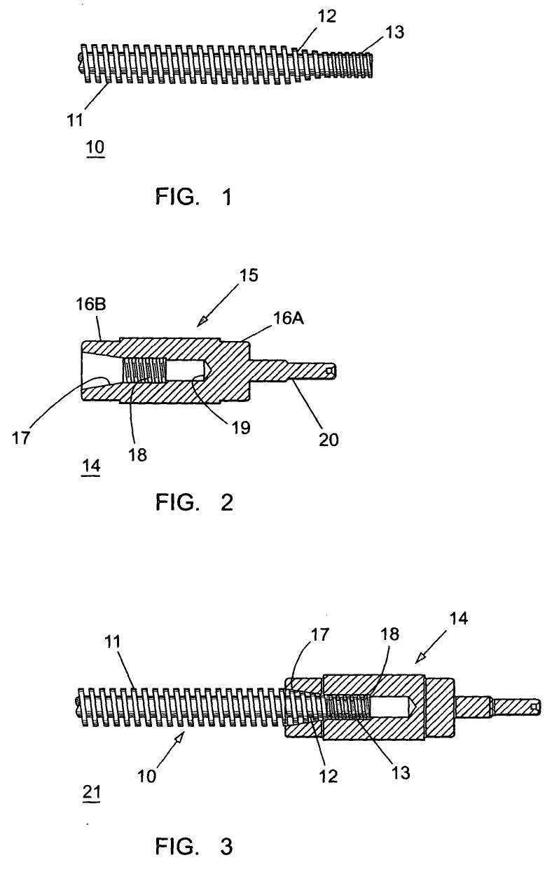

As shown in FIG. 1, a lead screw 10 is depicted in the form of a first threaded metal rod 11 similar to that described within the aforementioned U.S. Pat. No. 7,086,303 and differs therefrom by inclusion of a conical section 12 terminating in a second diameter threaded metal rod 13 of smaller diameter than the first threaded metal rod 11.

In further accordance with the invention, as shown in FIG. 2, a customized motor shaft 14 defining a rotor support rod 15, which includes a pair of bearing journals 16A, 16B, on the exterior surface thereof and a cone-shaped aperture 17 at one end leading to a threaded circular aperture 18 and a non-threaded circular aperture 19. A shaft 20 extends from the opposite end of the motor support rod 15 for function within a stepper motor assembly as described within U.S. Pat. No. 6,967,425 entitled “Multi-functional Electric Stepper Motor Assembly Having Increased Motor Torque”.

The combined rotor shaft-lead screw assembly 21 is now depicted in

FIG. 3 with the threaded metal rod 13 engaged within the threaded circular aperture 18 such that the conical section 12 sits within the cone-shaped aperture 17 and the threaded metal rod 11 on the lead screw 10 extends therefrom the rotor shaft 14.

Although the attachment of the lead screw 10 to the rotor shaft 14 is shown prior to completion of the stepper motor, this is for purposes of clarity. In actuality, the rotor shaft 14 is part of the complete stepper motor assembly (not shown) and the lead screw 10 is assembled therein after such assembly.
This allows lead screws of various lengths and configurations to be assembled to a stepper motor without having to design each stepper motor for each lead screw, per se, which is an important feature of the invention.

A linear actuator arrangement has herein been described whereby a simple adjustment to the rotor shaft of a stepper motor and the like is adjusted to receive a plurality of sized lead screws without having to design and adjust each and every stepper motor to accommodate each and every sized lead screw, as described earlier.

What is claimed is:

1. A lead screw adapter for an electric motor comprising in combination:
a first threaded rod of a first length and a first diameter;
a second threaded rod at an opposite end of said first rod, said second threaded rod being of a shorter length and smaller diameter than said first threaded rod; and
a third threaded rod of a conical configuration intermediate said first and second threaded rods.

2. The lead screw adapter of claim 1 further including means for receiving said first, second and third threaded rods within an electric motor.

3. The lead screw adapter of claim 2 wherein said means for receiving said first, second and third threaded rods comprises a rotor shaft.

4. The lead screw adapter of claim 3 wherein said rotor shaft defines a shaft extension at one end and a conical aperture at an opposite end thereof.

5. The lead screw adapter of claim 4 wherein said rotor shaft includes a pair of bearing journals formed on an outer surface.

6. The lead screw adapter of claim 4 wherein said rotor shaft includes a threaded aperture formed therein in abutment with one end of said conical aperture for receiving said second threaded rod to thereby attach said first, second and third threaded rods to said rotor shaft.

7. The lead screw adapter of claim 6 wherein said rotor shaft further includes a circular aperture formed therein in abutment with one end of said threaded aperture.

8. A combined lead screw adapter and rotor shaft for an electric motor comprising:
a rotor shaft including a shaft extension at one end and a conical aperture at an opposite end thereof;
said rotor shaft further including a threaded aperture formed therein in abutment with one end of said conical aperture and a circular aperture formed therein in abutment with one end of said threaded aperture;
a first threaded rod of a first length and a first diameter;
a second threaded rod at an opposite end of said first rod, said second threaded rod being of a shorter length and smaller diameter than said first threaded rod; and
a third threaded rod of a conical configuration intermediate said first and second threaded rods, whereby said first, second and third threaded rods are attached to said rotor shaft by engagement of said second threaded rod within said threaded aperture formed within said rotor shaft.
